(19) United States
(12) Patent Application Publication
(10) Pub. No.: US 2010/0020654 A1
(43) Pub. Date: Jan. 28, 2010

(54) METHOD AND APPARATUS FOR DATA BUFFER CONTROL OF OPTICAL DISC PLAYER

(75) Inventors: Ping-Tsai Tsai, Kaohsiung City (TW); Shih-Rong Kao, Hsinchu City (TW); Bang-Cheng Chen, Kaohsiung City (TW); Pin-Chou Liu, Taipei County (TW); Sung-Yang Wu, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/180,653

(22) Filed: Jul. 28, 2008

(51) Int. Cl. G11B 5/09

(52) U.S. Cl. 369/47.15

(57) ABSTRACT

An optical disc player for playback of a multimedia file stored in an optical disc is disclosed. The optical disc player includes a front-end loader and a back-end playback engine. The front-end loader, including a first data buffer, reads data from the optical disc and stores the read data in the first data buffer when the amount of data stored in the first data buffer is less than a first threshold. The back-end playback engine receives the data from the first data buffer and plays a multimedia segment corresponding to the received data. The front-end loader increases the first threshold of the first data buffer before a time-consuming servo behavior occurs.

### BACKGROUND OF THE INVENTION

1. Field of the Invention

The invention relates to an optical disc player, and more particularly to optical disc players capable of buffer control in response to some time-consuming servo behaviors to smoothly play back multimedia files.

2. Description of the Related Art

Optical discs are widely known as having the capability to have optical recorded media information recorded or played back onto or from thereof For example, discs based on various standards, such as compact disc (CD), digital versatile disc (DVD), high-definition (HD) DVD, and Blu-Ray disc, have been developed. Information is recorded on or played back from optical disks by irradiating an optical disc with tiny light beams, wherein light beams are generated from a semiconductor laser or the like as a light source. As is publicly known, in order to keep the laser light focused on a recording layer of an optical disc, a focus servo operation is executed.

In recent years, optical discs having multiple recording layers have been developed to improve storage capacity. For such multilayered optical discs, in order to move from a recording/playback operation for one recording layer to another recording layer, layer change is performed. Because relatively much time is required for the laser head to read from one recording layer to another, the layer change behavior may result in unexpected pausing, when a video file, recorded in the optical disk, is playing. Therefore, a need exists in the art to address the aforementioned deficiencies and inadequacies.

### BRIEF SUMMARY OF THE INVENTION

The invention provides an optical disc player for playback of a multimedia file stored in an optical disc. The optical disc player comprises a front-end loader and a back-end playback engine. The front-end loader, comprising a first data buffer, reads data from the optical disc and stores the read data in the first data buffer when the amount of data stored in the first data buffer is less than a first threshold. The back-end playback engine receives the data from the first data buffer and plays a multimedia segment corresponding to the received data. The front-end loader increases the first threshold of the first data buffer before a time-consuming servo behavior occurs.

The invention also provides an optical disc player for playback of a multimedia file stored in an optical disc. The optical disc player comprises a front-end loader and a back-end playback engine. The front-end loader, comprising a first memory which comprises a first data buffer, reads data from the optical disc and stores the data in the first data buffer. The back-end playback engine receives data from the first data buffer and plays a multimedia segment corresponding to the received data. The front-end loader enlarges the size of the first data buffer before a time-consuming servo behavior occurs.

### BRIEF DESCRIPTION OF THE DRAWINGS

The invention can be more fully understood by reading the subsequent detailed description and examples with references made to the accompanying drawings, wherein:

FIG. 1 is an embodiment of an optical disc player according an embodiment to the invention;

FIG. 2 shows an example of a buffer strategy using a buffer threshold in a data buffer;

FIG. 3 shows an example of a re-buffer behavior between an optical disk and a laser head;

FIG. 4 shows an example of two time-consuming servo behaviors; and

FIG. 5 shows an example of memory allocation for data buffer enlargement.

### DETAILED DESCRIPTION OF THE INVENTION

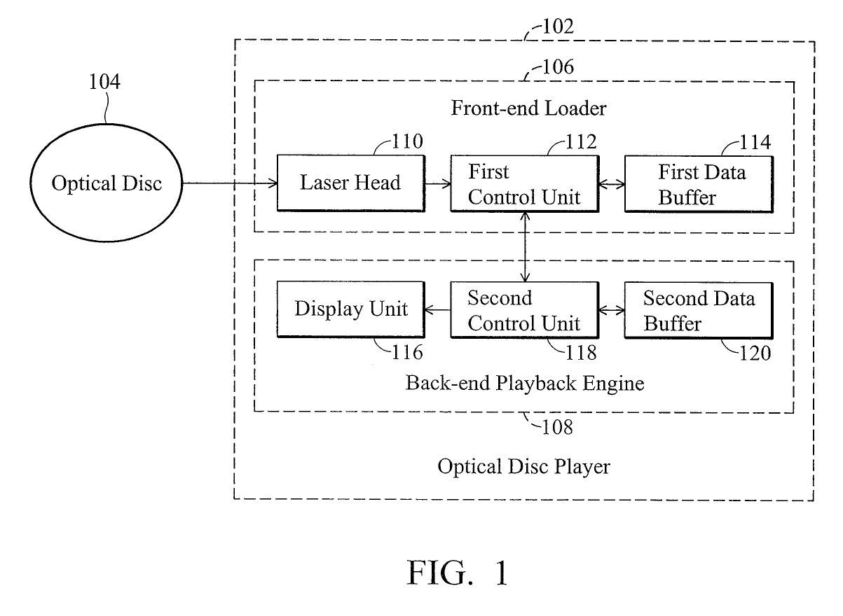

FIG. 1 is an embodiment of an optical disc player according an embodiment of to the invention. The optical disc player 102 may comprise a front-end loader 106 to read data from an optical disc 104 and a back-end playback engine 108 to play back the data. The optical disc 104 may have multiple layers storing a multimedia file such as a movie file, and may be a DVD, HD-DVD, or Blu-Ray disc. The front-end loader 106 may comprise a laser head 110, a first control unit 112, and a first data buffer 114. The first data buffer 114 may be implemented in a first memory (not shown) of the front-end loader 106, and the first memory may be a volatile memory such as static random access memory (SRAM) or dynamic random access memory (DRAM). The back-end playback engine 108 may comprise a display unit 116, a second control unit 118, and a second data buffer 120. The second data buffer 120 may be implemented in a second memory (not shown) of the back-end playback engine 108, and the second memory may be a volatile memory such as SRAM or DRAM. The laser head 110 can sense a light beam reflected by the optical disc 104 to read the data stored at a position of the optical disc 104. The first control unit 112 may receive the data from the laser head 110 and store the data in the first data buffer 114. The second control unit 118 may request the first control unit 112 to acquire the data stored in the first control buffer 114, and then store the acquired data in the second data buffer 120. Next, the data stored in the second control buffer 120 would be forwarded to the display unit 116 to play a multimedia segment (e.g., a movie segment) of the data.

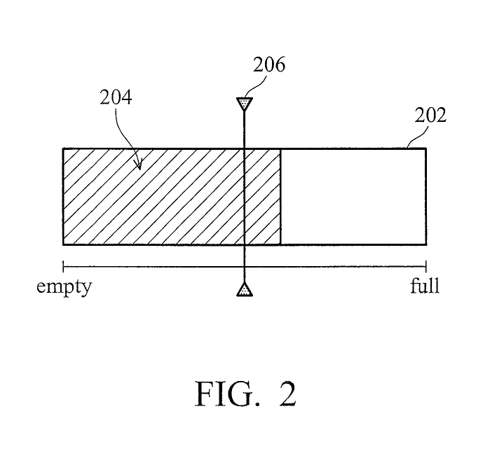

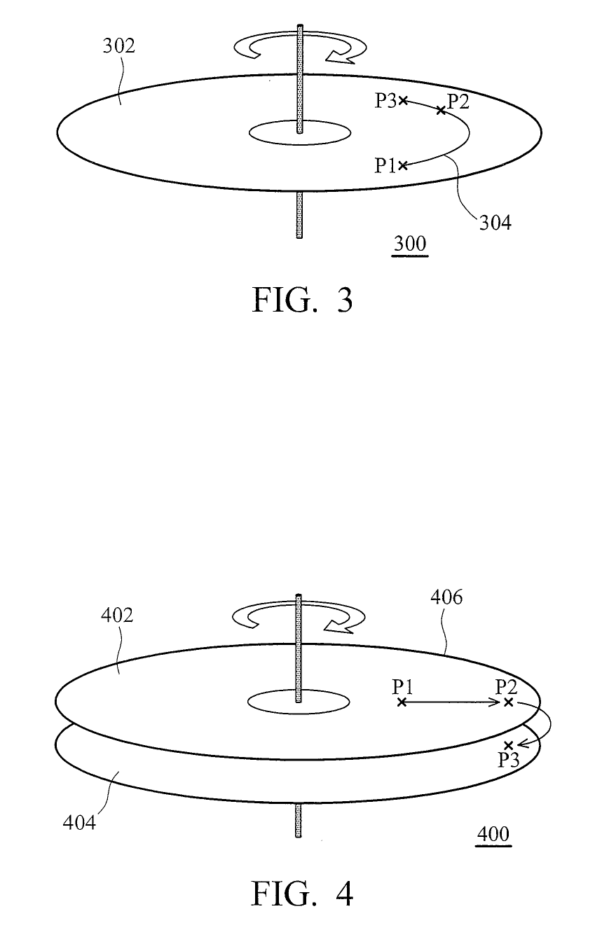

In one embodiment, the optical disc player 102 may change buffer strategies in response to the occurrence of some time-consuming servo behaviors. For example, buffer thresholds may be used to control the amount of data stored in the first data buffer 114 or in the second data buffer 120. FIG. 2 shows an example of a buffer strategy using a buffer threshold in a data buffer. Referring to FIG. 2, a buffer gauge 202 represents the size of the data buffer, a dark area 204 in the buffer gauge 202 represents the amount of data stored in the data buffer, and a threshold 206 represents one buffer strategy of the data buffer. When the data is removed out from the data buffer (e.g., the second control unit 118 informs the first control unit 112 to acquire the data stored in the first data buffer 114, or the display unit 116 prepares to process the data stored in the second data buffer 120), the dark area 204 would be reduced from right to left in the buffer gauge 202. Suppose that the threshold 206 is used as the buffer threshold for the data buffer, no data would be further stored into the data buffer because the amount of the data stored in the data buffer is larger than the threshold 206 (i.e. the dark area 204 exceeds the threshold 206). However, if the amount of data stored in the data buffer is reduced to less than the threshold 206, the data buffer would be required to store more data until the data buffer is full (i.e. buffer gauge 202 is filled up with the dark area 204). The buffer strategy keeps the amount of data stored in the data buffer to be larger than the buffer threshold, allowing the buffer threshold to be increased when required, for example, before a time-consuming servo behavior is anticipated to occur, thereby increasing the amount of data stored in the data buffer to ensure that the data stored in the data buffer will not run out when the time-consuming servo behavior takes place. It is noted that increasing the buffer threshold of the data buffer will also increase the re-buffer frequency. FIG. 3 shows an example of re-buffer behavior between an optical disk and a laser head. An optical disc 300 may comprise multiple layers, but only one layer 302 is depicted in FIG. 3 for brevity. The optical disc 300 may be clockwise rotated along the axis of the optical disc 300. A trajectory 304 represents the relative movement between the laser head (not shown) and the optical disc 300. P1, P2, and P3 are different positions of the trajectory 304 on the optical disc 300. First, the laser head is focused on P1 of the optical disc 300. Once the amount of data stored in the data buffer (not shown) is reduced to less than the buffer threshold, the laser head reads data along the trajectory 304 until the data buffer is full. The data buffer will be full when the laser head reaches P2, whereafter the laser head is moved to P3 along the trajectory 304 but not P2 because of the rotating inertia of the optical disc 300. As the laser head is required to re-buffer data when the amount of data is reduced to less than the buffer threshold, the laser head is then refocused on P2. Note that the frequency of the re-buffer behavior will increase if the buffer threshold is increased, because the amount of data stored in the data buffer reduced to less than the increased buffer threshold would more often occur.

Referring back to FIG. 1, the front-end loader 106 may start reading data from the optical disc 104 and store the read data in the first data buffer 114 when the amount of data stored in the first data buffer 114 is less than a first threshold, and the front-end loader 106 may increase the first threshold of the first data buffer 114 to store more data in the first data buffer 114 before a time-consuming servo behavior occurs. The first control unit 112 may anticipate the occurrence of the time-consuming servo behavior according to the position of the optical disc 104 on which the laser head 110 is focused and a moving direction of the laser head 110, and increase the first threshold of the first data buffer 114 when the occurrence of the time-consuming servo behavior is anticipated to occur. The first control unit 112 may anticipates the occurrence of a time-consuming servo behavior when the position is close to the outer rim of the optical disc 104 and the moving direction of the laser head 110 is directed to the outer rim. Similarly, another buffer threshold may be used to control the amount of data stored in the second data buffer 120. The second control unit 118 may start receiving data from the first data buffer 114 and store the received data in the second data buffer 120 when the amount of the data stored in the second data buffer 120 is less than a second threshold. Also, the buffer strategies of the second data buffer 120 may be changed in response to the occurrence of the time-consuming servo behaviors. For example, the first control unit 112 may send a signal that informs the second control unit 118 to increase the second threshold of the second data buffer 120 when the first control unit 112 anticipates the occurrence of the time-consuming servo behavior. Also, the second control unit 118 may anticipate the occurrence of the time-consuming servo behavior by examining file system information of the optical disc 104 or examining the data that the display unit 116 is preparing to process. The second control unit 118 may send a signal to inform the first control unit 112 to increase the first threshold of the first data buffer 114 when the second control unit 118 anticipates the occurrence of the time-consuming servo behavior. It is noted that increasing first threshold of the first data buffer 114 or increasing the second threshold of the second data buffer 120 will also increase the re-buffer frequency.

The time-consuming servo behavior may be a layer change between two layers of the optical disc, or a long-distance seek between two positions of the optical disc. FIG. 4 shows an example of the two time-consuming servo behaviors. An optical disc 400 comprises a first layer 402 and a second layer 404. P1 and P2 are two positions located on the first layer 402 with long distances, and P3 is a position located on the second layer 404. Note that P2 is very close to the outer rim of the first layer 402. The long-distance seek, for example, occurs when the laser head is required to read the data stored in P2 immediately after reading the data stored in P1. The long-distance seek may be anticipated by examining file system information of the optical disc 400 because the file system information may indicate which data is stored in which position on the optical disc 400, or by examining the data prepared to be processed to play back because the data may comprise information about the next position required to be read. The layer change, for example, occurs when the laser head is required to read the data stored in P3 after reading the data stored in P2. The layer change can be anticipated by determining whether the position on which the laser head is focusing is close to the outer rim 406 and the moving direction of the laser head is also directed to the outer rim 406. The layer change can also be anticipated by examining file system information of the optical disc 400 or the data which is prepared to be processed to play back.

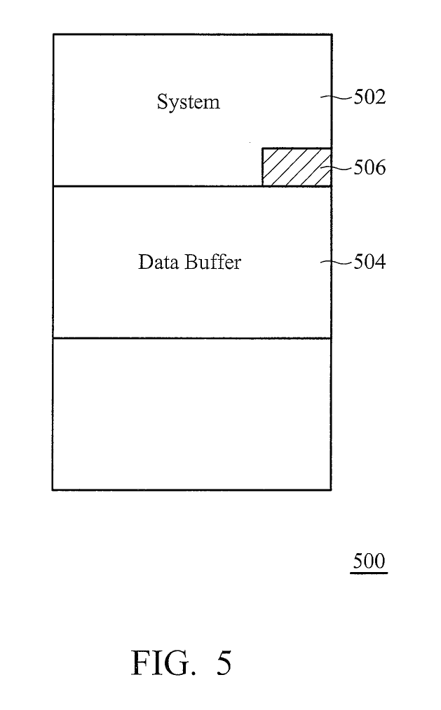

In another embodiment, the optical disc player 102 may enlarge the buffer size of the data buffer in response to the occurrence of some time-consuming servo behaviors. FIG. 5 shows an example of memory allocation for data buffer enlargement. A volatile memory 500, such as SRAM and DRAM, may be partitioned into several sections. For example, a section 502 of the volatile memory 500 may be allocated for the storage of system program, and another section 504 of the volatile memory 500 may be allocated as the data buffer. When the time-consuming servo behavior is anticipated to occur, an automatic memory management (e.g., garbage collection) may be executed to collect a temporarily unused area 506 in the section 502 of the system program, thereby allowing the unused area 506 to be reallocated to the data buffer 504 to temporarily enlarge the size of the data buffer 504. Enlarging the size of the data buffer when the time-consuming servo behavior is anticipated to occur can ensure that the data stored in the data buffer will not run out when the time-consuming servo behavior takes place.

Referring back to FIG. 1, the first control unit 112 may enlarge the size of the first data buffer 114 by performing a garbage collection to acquire an unused memory area of the first memory (not shown) and adding the unused memory area to the first data buffer 114 before a time-consuming servo behavior occurs. Also, the first control unit 112 may anticipate the occurrence of the time-consuming servo behavior according to the position on which the laser head 110 is focusing and a moving direction of the laser head 110, and enlarge the size of the first data buffer 114 when the time-consuming servo behavior is anticipated to occur. The occurrence of the time-consuming servo behavior (e.g., layer change) may be anticipated by the first control unit 112 when the position is close to the outer rim of the optical disc 104 and the moving direction of the laser head 110 is directed to the outer rim. Moreover, the first control unit 112 may further send a signal to inform the second control unit 118 to enlarge the size of the second data buffer 120. The second control unit 118 may perform a garbage collection to acquire an unused memory area of the second memory (not shown) and add the unused memory area to the second data buffer 120 when receiving the signal sent from the first control unit 112. The second control unit 118 may further anticipate the occurrence of the time-consuming servo behavior (e.g., layer change and long-distance seek) by examining file system information of the optical disc 104 or examining the data prepared to be processed by the display unit 116. Also, the second control unit 118 may send a signal to inform the first control unit 112 to enlarge the size of the first data buffer 114 when the time-consuming servo behavior is anticipated to occur.

While the invention has been described by way of examples and in terms of preferred embodiments, it is to be understood that the invention is not limited thereto. Any variation or modification can be made by those skilled in art without departing from the spirit or scope of the invention. Therefore, the scope of the appended claims should be accorded the broadest interpretation to encompass all such modifications and similar arrangements.

What is claimed is:

1. An optical disc player for playback of a multimedia file stored in an optical disc, comprising:
a front-end loader, comprising a first data buffer, configured to read data from the optical disc and store the read data in the first data buffer when the amount of data stored in the first data buffer is less than a first threshold; and
a back-end playback engine, configured to receive the data from the first data buffer and play a multimedia segment corresponding to the received data, wherein the front-end loader increases the first threshold of the first data buffer before a time-consuming servo behavior occurs.

2. The optical disc player as claimed in claim 1, wherein the time-consuming servo behavior is a layer change between multiple layers of the optical disc or a long-distance seek between two positions of the optical disc.

3. The optical disc player as claimed in claim 1, wherein the front-end loader further comprises:
a laser head, configured to sense a light beam reflected by the optical disc to read the data stored at a position of the optical disc; and
a first control unit, configured to anticipate the occurrence of the time-consuming servo behavior according to the position of the optical disc and a moving direction of the laser head, and increase the first threshold of the first data buffer when the occurrence of the time-consuming servo behavior is anticipated to occur.

4. The optical disc player as claimed in claim 3, wherein the occurrence of the time-consuming servo behavior is anticipated to occur when the position of the optical disc is close to an outer rim of the optical disc and the moving direction of the laser head is directed to the outer rim.

5. The optical disc player as claimed in claim 3, wherein the back-end playback engine further comprises:
a second data buffer; and
a second control unit, configured to receive data from the first data buffer and store the received data in the second data buffer when the amount of the data stored in the second data buffer is less than a second threshold, wherein the first control unit is further configured to send a signal to inform the second control unit to increase the second threshold of the second data buffer when the time-consuming servo behavior is anticipated to occur.

6. The optical disc player as claimed in claim 5, wherein the second control unit is further configured to anticipate the occurrence of the time-consuming servo behavior by examining file system information of the optical disc or examining the data corresponding to the multimedia segment and send a signal to inform the first control unit to increase the first threshold of the first data buffer when the time-consuming servo behavior is anticipated to occur.

7. The optical disc player as claimed in claim 1, wherein the front-end loader further comprises:
a laser head, configured to sense a light beam reflected by the optical disc to read the data at a position of the optical disc; and
a first control unit, configured to increase the first threshold of the first data buffer when receiving a signal indicating the occurrence of the time-consuming servo behavior.

8. The optical disc player as claimed in claim 7, wherein the back-end playback engine further comprises a second control unit configured to anticipate the occurrence of the time-consuming servo behavior by examining a file system of the optical disc or examining the data corresponding to the multimedia segment and send the signal to the first control unit when the time-consuming servo behavior is anticipated to occur.

9. The optical disc player as claimed in claim 8, wherein the second control unit is further configured to receive data from the first data buffer and store the received data in a second data buffer of the back-end playback engine when the amount of the data stored in the second data buffer is less than a second threshold, and increase the second threshold of the second data buffer when the time-consuming servo behavior is anticipated to occur.

10. The optical disc player as claimed in claim 1, wherein the optical disc is a digital versatile disc (DVD), a high-definition (HD) DVD, or a blu-ray disc (BD).

11. An optical disc player for playback of a multimedia file stored in an optical disc, comprising:
a front-end loader, comprising a first memory which comprises a first data buffer, configured to read data from the optical disc and store the data in the first data buffer; and
a back-end playback engine, configured to receive data from the first data buffer and play a multimedia segment corresponding to the received data, wherein the front-end loader enlarges the size of the first data buffer before a time-consuming servo behavior occurs.

12. The optical disc player as claimed in claim 11, wherein the time-consuming servo behavior is a layer change between multiple layers of the optical disc or a long-distance seek between two positions of the optical disc.

13. The optical disc player as claimed in claim 11, wherein the front-end loader further comprises:
a laser head, configured to sense a light beam reflected by the optical disc to read the data at a position of the optical disc; and
a first control unit, configured to anticipate the occurrence of the time-consuming servo behavior according to the position of the optical disc and a moving direction of the laser head, and enlarge the size of the first data buffer when the time-consuming servo behavior is anticipated to occur.

14. The optical disc player as claimed in claim 13, wherein the occurrence of the time-consuming servo behavior is anticipated to occur when the position of the optical disc is close to an outer rim of the optical disc and the moving direction of the laser head is directed to the outer rim.

15. The optical disc player as claimed in claim 13, wherein the back-end playback engine further comprises:
a second memory which comprises a second data buffer; and
a second control unit, configured to receive the data corresponding to the multimedia segment from the first data buffer and store the received data in the second data buffer, wherein the first control unit is further configured to send a first signal to inform the second control unit to enlarge the size of the second data buffer when the time-consuming servo behavior is anticipated to occur.

16. The optical disc player as claimed in claim 15, wherein the second control unit is further configured to anticipate the occurrence of the time-consuming servo behavior by examining a file system of the optical disc or examining the data corresponding to the multimedia segment, and sending a second signal to inform the first control unit to enlarge the size of the first data buffer when the time-consuming servo behavior is anticipated to occur.

17. The optical disc player as claimed in claim 13, wherein the first control unit enlarges the size of the first data buffer by performing a garbage collection to acquire an unused memory area of the first memory and adding the unused memory area to the first data buffer.

18. The optical disc player as claimed in claim 11, wherein the time-consuming servo behavior is a layer change between multiple layers of the optical disc, and the front-end loader further comprises:
a laser head, configured to sense a light beam reflected by the optical disc to read the data at a position of the optical disc; and
a first control unit, configured to enlarge the size of the first data buffer when the first control unit detects that the position of the optical disc is close to an outer rim of the optical disc and the moving direction of the laser head is directed to the outer rim.

19. The optical disc player as claimed in claim 11, wherein the back-end playback engine further comprises:
a second memory which comprises a second data buffer to store the data corresponding to the multimedia segment; and
a second control unit configured to enlarge the size of the second data buffer by performing a garbage collection to acquire an unused memory area of the second memory and adding the unused memory area to the first data buffer before a time-consuming servo behavior occurs.

20. The optical disc player as claimed in claim 11, wherein the optical disc is a digital versatile disc (DVD), a high-definition (HD) DVD, or a blu-ray disc (BD)
